(19) United States
(12) Patent Application Publication
(10) Pub. No.: US 2025/0144775 A1
(43) Pub. Date: May 8, 2025

(54) ELECTRIC TOOL

(71) Applicant: MAXELL IZUMI CO., LTD., Matsumoto-shi, Nagano (JP)

(72) Inventors: Keiichiro KAMIJO, Matsumoto-shi, Nagano (JP); Katsutoshi KOCHIYAMA, Matsumoto-shi, Nagano (JP)

(21) Appl. No.: 18/726,118

(22) PCT Filed: May 18, 2022
(86) PCT No.: PCT/JP2022/020604

§ 371 Date: Jul. 2, 2024

(51) Int. Cl. B25B 25/00; B25F 5/00; B25F 5/02

(52) U.S. Cl. CPC B25B 25/00; B25F 5/005; B25F 5/029

(57) ABSTRACT

An electric tool configured to be capable of efficiently raise a pressure. The electric tool having a body part in which a cylinder part, an oil tank, a hydraulic pump that feeds hydraulic oil to the cylinder part, an electric motor that drives the hydraulic pump, and a control circuit are arranged; a tool head actuated by a piston in a state of being connected to the body part, a battery that supplies power to the electric motor, and a sensor that detects the state of the hydraulic oil, the control circuit being configured so as to control driving of the electric motor based on a detection signal from the sensor.

### TECHNICAL FIELD

The present invention relates to a hydraulic electric tool.

### BACKGROUND ART

In the related art, a hydraulic electric tool is known (PTL 1: JP2018-086696A).

### CITATION LIST

### Patent Literature

PTL 1: JP2018-086696A

### SUMMARY OF INVENTION

### Technical Problem

An electric tool may be used in a state where a main body is at a low temperature, when the electric tool is used in a place where an air temperature is low. Recently, the following is found. A hydraulic oil has a property that a viscosity becomes higher as a temperature is lowered. Therefore, when a rotation speed of an electric motor increases in a state where the viscosity of the hydraulic oil is high, a phenomenon occurs in which the hydraulic oil cannot be fed in accordance with a liquid feeding operation of the hydraulic pump, and a pressure raising time is lengthened.

### Solution to Problem

The present invention is made in view of the above described circumstances, and aims to provide an electric tool having a configuration which can efficiently raise a pressure, compared to the related art, by controlling a rotation speed of an electric motor such that a hydraulic oil is fed in accordance with a liquid feeding operation of a hydraulic pump in response to a state of the hydraulic oil, such as a temperature and a viscosity.

The present invention has been accomplished under the solutions as disclosed below.

According to an aspect of the present invention, there is provided an electric tool including a main body in which a cylinder part having a piston, an oil tank, a hydraulic pump for feeding a hydraulic oil inside the oil tank to the cylinder part, an electric motor for driving the hydraulic pump, and a control circuit are disposed, a tool head operated by the piston in a state of being connected to the main body, a battery that supplies power to the electric motor, and a sensor that detects a state of the hydraulic oil. The control circuit drives and controls the electric motor, based on a detection signal from the sensor.

According to this configuration, the control circuit drives and controls the electric motor, based on the detection signal of the sensor that detects the state of the hydraulic oil. Therefore, a pressure can be more efficiently raised, and a pressure raising time can be shortened, compared to a tool in the related art. In addition, a life of a battery is lengthened by an efficient operation.

It is preferable that the sensor is any one or more of a temperature sensor, a viscosity sensor, a flow sensor, and a pressure sensor. In a case of the temperature sensor, the hydraulic oil can be fed in accordance with a liquid feeding operation of the hydraulic pump by intentionally lowering a rotation speed of the electric motor when a temperature of the hydraulic oil is low. In a case of the viscosity sensor, the hydraulic oil can be fed in accordance with the liquid feeding operation of the hydraulic pump by intentionally lowering the rotation speed of the electric motor when a viscosity of the hydraulic oil is high. In a case of the flow sensor, the hydraulic oil can be fed in accordance with the liquid feeding operation of the hydraulic pump by intentionally lowering the rotation speed of the electric motor when a flow rate of the hydraulic oil is lower than a setting value. In a case of the pressure sensor, the hydraulic oil can be fed in accordance with the liquid feeding operation of the hydraulic pump by intentionally lowering the rotation speed of the electric motor when pressure raising of the hydraulic oil is slower than the setting value.

As an example, the control circuit calculates the temperature of the hydraulic oil, based on the detection signal, and lowers the rotation speed of the electric motor from the setting value when the calculated temperature of the hydraulic oil is lower than a reference value. As the electric motor, a brushless motor, a carbon brush motor, a universal motor, or other known electric motors can be adopted. In a case of the brushless motor, a position of a rotor can be detected by a Hall element, and the rotation speed can be controlled by an inverter. In a case of the carbon brush motor or the universal motor, the rotation speed can be controlled by performing linear control of increasing an input voltage value in response to a temperature rise, pulse control of increasing a duty ratio of an input voltage pulse in response to a temperature rise, or voltage switching control of switching an input voltage value when the temperature reaches the setting value.

It is more preferable that the sensor is a contact type temperature sensor. In this manner, the sensor can be easily accommodated inside a main body with a simple configuration.

As an example, the sensor is disposed inside the oil tank. In this manner, the state of the hydraulic oil can be directly detected. Therefore, the electric tool can be easily controlled with high accuracy. As an example, the sensor may be attached to a metal portion of the oil tank.

As an example, the sensor is in contact with an outer side of the oil tank. In this manner, the sensor can be attached later by using the oil tank as an existing configuration. Therefore, assembly work can be facilitated, and maintenance work can be facilitated.

As an example, the sensor is in contact with an outer side of the cylinder part. In this manner, the sensor can be attached later by using the cylinder part as an existing configuration. Therefore, assembly work can be facilitated, and maintenance work can be facilitated. As an example, the sensor is attached to a metal portion of the cylinder part.

As an example, the sensor is disposed inside the cylinder part. In this manner, while the oil tank is used as the existing configuration, the state of the hydraulic oil can be directly detected. Therefore, the electric tool can be easily controlled with high accuracy. As an example, a first hydraulic line that feeds the hydraulic oil is formed inside the cylinder part, and the sensor is disposed inside a second hydraulic line connected to the first hydraulic line. In this manner, while a flow of the hydraulic oil can be maintained, the state of the hydraulic oil can be directly detected. Therefore, the electric tool can be easily controlled with high accuracy.

As an example, a battery pack formed by a battery such as a lithium-ion battery and a nickel-metal hydride battery is connected to an adapter of the main body, and the adapter is connected to a handle of the main body. In this manner, it is possible to provide the electric tool having excellent portability.

### Advantageous Effects of Invention

According to the present invention, it is possible to provide an electric tool having a configuration which can efficiently raise a pressure, compared to the related art, by controlling a rotation speed of an electric motor such that a hydraulic oil is fed in accordance with a liquid feeding operation of a hydraulic pump in response to a state of the hydraulic oil, such as a temperature and a viscosity.

### BRIEF DESCRIPTION OF DRAWINGS

FIG. 1 is a schematic side view illustrating an example of an electric tool according to an embodiment of the present invention.

FIG. 2A is a schematic structural view illustrating a first example of a sensor disposition in an electric tool illustrated in FIG. 1, FIG. 2B is a schematic structural view illustrating a second example of the sensor disposition in the electric tool illustrated in FIG. 1, FIG. 2C is a schematic structural view illustrating a third example of the sensor disposition in the electric tool illustrated in FIG. 1, and FIG. 2D is a schematic structural view illustrating the fourth example of the sensor disposition in the electric tool illustrated in FIG. 1.

### DESCRIPTION OF EMBODIMENTS

Hereinafter, an embodiment of the present invention will be described in detail with reference to the drawings. The present embodiment is an electric pressing tool, an electric crimping tool, an electric cutting tool, or other known hydraulic electric tools. In all drawings for describing the embodiment, the same reference numerals will be assigned to members having the same function, and repeated description thereof may be omitted in some cases.

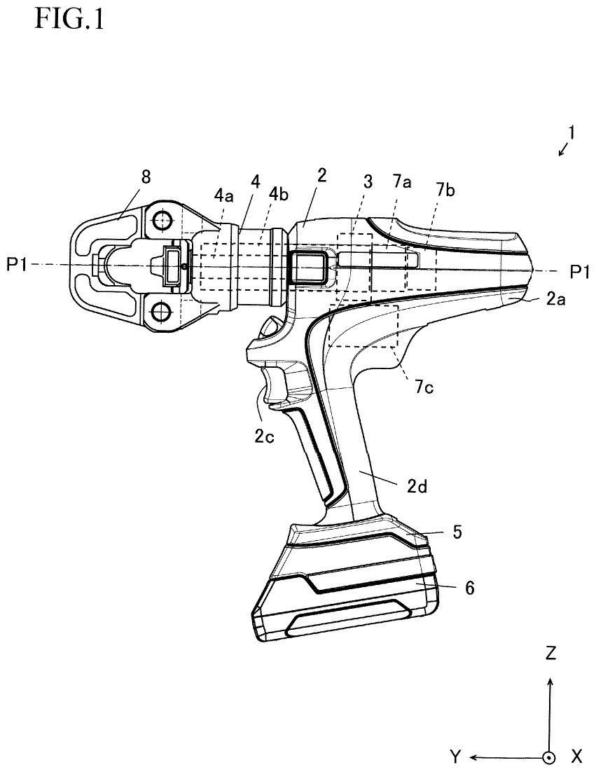

FIG. 1 is a schematic view illustrating an example of an electric tool 1 according to the present embodiment. The electric tool 1 includes a main body 2, a tool head 8 operated by a piston 4a in a cylinder part 4 of the main body 2 in a state of being connected to the main body 2, and a battery 6 that supplies power to an electric motor 7b of the main body 2, and is a cordless type tool used by an operator holding the tool with a hand at a work site. Here, in order to facilitate description of a positional relationship of each part of the electric tool 1, directions are indicated by arrows X, Y, and Z in the drawing. The piston 4a performs a reciprocating motion along a first axis P1. That is, the piston 4a moves forward to a side of an arrow in a Y-direction in the drawing, and moves rearward to a side opposite to the arrow in the Y-direction in the drawing. An example in FIG. 1 represents the tool head 8 of the electric pressing tool, and represents the multifunctional electric tool 1 in which the tool head 8 is replaced. The electric tool 1 is normally operated in any orientation regardless of an orientation when work is carried out.

The main body 2 is provided with the cylinder part 4 in which the piston 4a is disposed in a piston chamber 4b, an oil tank 3 attached to an outer side of the cylinder part 4 closer to a hydraulic pump 7a, the hydraulic pump 7a connected to the cylinder part 4 to feed a hydraulic oil 3a inside the oil tank 3 to the piston chamber 4b of the cylinder part 4, the electric motor 7b connected to the hydraulic pump 7a to drive the hydraulic pump 7a, and a control circuit 7c that drives and controls the electric motor 7b. The battery 6 that supplies power to the electric motor 7b and the control circuit 7c is connected to an adapter 5 of the main body 2 in a state of the battery pack, and the adapter 5 is connected to a handle 2d of the main body 2. The handle 2d is a gripping portion gripped by the operator, and is provided with a start switch 2c. In the present embodiment, a sensor 9 that detects a state of the hydraulic oil 3a is disposed in the main body 2, and the control circuit 7c drives and controls the electric motor 7b, based on a detection signal from the sensor 9.

As an example, the hydraulic pump 7a is an inclined plate type piston pump having a swash plate cam rotated by a drive shaft of the electric motor 7b. The piston chamber 4b of the cylinder part 4 and the hydraulic pump 7a are connected in the cylinder part 4, and a first hydraulic line 11 that feeds the hydraulic oil 3a is formed inside the cylinder part 4.

As an example, the control circuit 7c calculates a temperature of the hydraulic oil 3a, based on a detection signal of a contact type temperature sensor 9, and lowers a rotation speed of the electric motor 7b from a setting value when a calculated value is lower than a reference value. In addition, the control circuit 7c calculates the temperature of the hydraulic oil 3a, based on the detection signal of the contact type temperature sensor 9, and raises the rotation speed of the electric motor 7b from the setting value when the calculated value is higher than the reference value.

### First Example

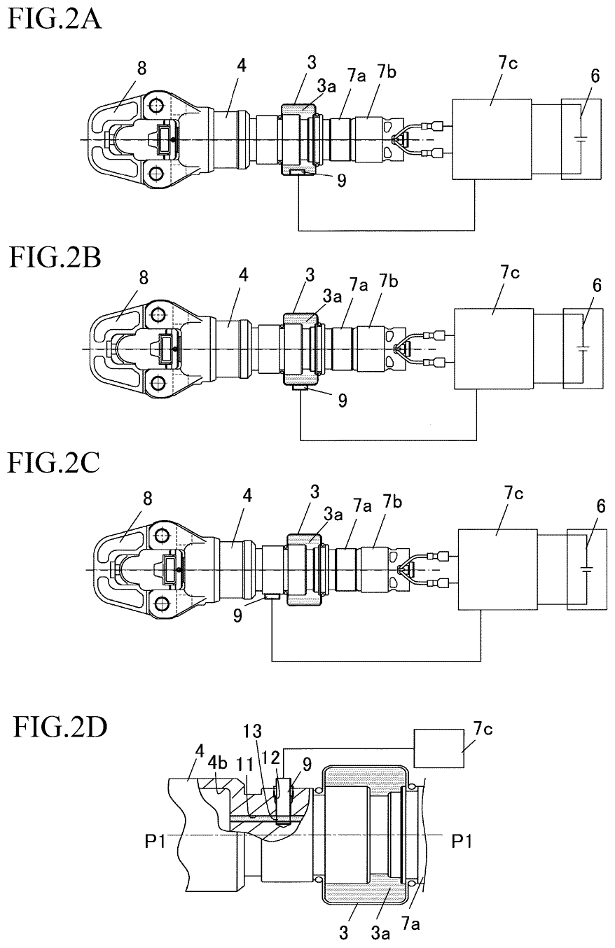

FIG. 2A is a schematic structural view illustrating a first example of a sensor disposition in the electric tool 1. The temperature sensor 9 is disposed inside the oil tank 3. As an example, the temperature sensor 9 is attached to a metal portion of the oil tank 3. In this manner, the state of the hydraulic oil 3a can be directly detected. Therefore, the electric tool can be easily controlled with high accuracy.

### Second Example

FIG. 2B is a schematic structural view illustrating a second example of the sensor disposition in the electric tool 1. The temperature sensor 9 is disposed in contact with an outer side of the oil tank 3. As an example, the temperature sensor 9 is attached to a metal portion of the oil tank 3. In this manner, the temperature sensor 9 can be attached later by using the oil tank 3 as an existing configuration. Therefore, assembly work can be facilitated, and maintenance work can be facilitated.

### Third Example

FIG. 2C is a schematic structural view illustrating a third example of the sensor disposition in the electric tool 1. The temperature sensor 9 is disposed in contact with an outer side of the cylinder part 4. As an example, the temperature sensor 9 is attached to a metal portion of the cylinder part 4. In this manner, the temperature sensor 9 can be attached later by using the oil tank 3 and the cylinder part 4 as existing configurations. Therefore, assembly work can be facilitated, and maintenance work can be facilitated.

### Fourth Example

FIG. 2D is a schematic structural view illustrating a fourth example of the sensor disposition in the electric tool 1. The first hydraulic line 11 for feeding the hydraulic oil 3a and a second hydraulic line 12 to which the temperature sensor 9 is attached are formed inside the cylinder part 4. The first hydraulic line 11 and the second hydraulic line 12 are connected in a hydraulic line joint 13, and the temperature sensor 9 is disposed inside the second hydraulic line 12. In this manner, while a flow of the hydraulic oil 3a can be maintained, the state of the hydraulic oil 3a can be directly detected. Therefore, the electric tool can be easily controlled with high accuracy.

In the above described example, a configuration has been described in which the electric motor 7b is driven and controlled by using the temperature sensor as the sensor 9. However, the present invention is not limited to this example. In the present embodiment, not only the temperature sensor but also a viscosity sensor, a flow sensor, or a pressure sensor can be adopted as the sensor 9. In addition, in some cases, two or more sensors that detect different physical quantities may be combined as the sensor 9. Alternatively, in some cases, a plurality of the same type of sensors may be used as the sensor 9.

In the above described example, a configuration has been described in which the battery 6 is detachably attached to the main body 2 in a state of the battery pack. However, the present invention is not limited to this example. In some cases, the present embodiment may adopt a configuration in which the battery 6 is incorporated, or a configuration in which these elements are combined.

The present invention is not limited to the embodiment described above, and various modifications can be made within the scope not departing from the present invention.

1. An electric tool comprising:
a main body in which a cylinder part having a piston, an oil tank, a hydraulic pump for feeding a hydraulic oil inside the oil tank to the cylinder part, an electric motor for driving the hydraulic pump, and a control circuit are disposed;
a tool head operated by the piston in a state of being connected to the main body;
a battery that supplies power to the electric motor; and
a sensor that detects a state of the hydraulic oil,
wherein the control circuit drives and controls the electric motor, based on a detection signal from the sensor.

2. The electric tool according to claim 1,
wherein the sensor is any one or more of a temperature sensor, a viscosity sensor, a flow sensor, and a pressure sensor.

3. The electric tool according to claim 1,
wherein the sensor is disposed inside the oil tank.

4. The electric tool according to claim 1,
wherein the sensor is in contact with an outer side of the oil tank.

5. The electric tool according to claim 1,
wherein the sensor is in contact with an outer side of the cylinder part.

6. The electric tool according to claim 1,
wherein the sensor is disposed inside the cylinder part.

7. The electric tool according to claim 1,
wherein the control circuit calculates a temperature of the hydraulic oil, based on the detection signal, and lowers a rotation speed of the electric motor from a setting value when the calculated temperature of the hydraulic oil is lower than a reference value.
